(19) United States
(12) Patent Application Publication
(10) Pub. No.: US 2007/0299830 A1
(43) Pub. Date: Dec. 27, 2007

(54) DISPLAY OF SEARCH RESULTS

(76) Inventors: Christopher Muenchhoff, Edinburgh (GB); Yevgeniy Lukyanov, Oryol (RU)

Correspondence Address: SCHWEGMAN, LUNDBERG & WOESSNER, P.A., P.O. BOX 2938, MINNEAPOLIS, MN, 55402, US

(21) Appl. No.: 11/767,305

(22) Filed: Jun. 22, 2007

Related U.S. Application Data
(60) Provisional application No. 60/805,832, filed on Jun. 26, 2006.

(51) Int. Cl. G06F 17/30

(52) U.S. Cl. 707/3

(57) ABSTRACT

In an example embodiment, a method for displaying a search result is provided. The method may comprise receiving a search query and a window size of a Web browser and accessing contents associated with a search of the search query. The contents are rendered to provide rendered images and each of the rendered images is scaled to a size of a rectangular portion of a grid layout. The size of the rectangular portion is based on the window size and a size of the grid layout. The scaled rendered images are transmitted to the Web browser, wherein the scaled rendered images are configured to be displayed in the grid layout.

### CROSS-REFERENCES TO RELATED APPLICATIONS

This application claims the benefit of U.S. Provisional Application No. 60/805,832, filed Jun. 26, 2006, the disclosure of which is incorporated herein by reference.

### FIELD

The present disclosure relates generally to information management and retrieval. In one example embodiment, the disclosure relates to display of search results.

### BACKGROUND

The Internet has become a popular computer communications network. Servers on the Internet store and offer a large amount of contents, such as Web pages, to clients. Internet search engines offer full text search services of contents located on the Internet. Users may enter search queries on Web pages provided by the search engines and get back search results in the form of hyperlinks to the contents, document title, and/or text extracts from the contents.

A drawback of these search results in the form of text is that the text do not provide not enough information to fully evaluate the search results. The text offer only a brief glimpse of the contents. To fully evaluate the search results, a user therefore has to click on the hyperlink of each search result to open the document in his Web browser. Often, the extra steps of clicking on the hyperlinks lead to the time consuming process of manually checking out several search results until an appropriate search result is found.

### BRIEF DESCRIPTION OF DRAWINGS

The present disclosure is illustrated by way of example and not limitation in the figures of the accompanying drawings, in which like references indicate similar elements and in which:

FIG. 1 is a diagram of an example embodiment of a graphical user interface (GUI) configured to display search results;

FIG. 2 is a diagram of an example embodiment of a networked system;

FIG. 3 is a simplified block diagram of an example embodiment of modules that may be included in an apparatus;

FIG. 4 is a flow diagram of a general overview of a method, in accordance with an example embodiment, for displaying a search result;

FIG. 5 is a diagram of an example embodiment of a GUI for inputting a size of a grid layout;

FIG. 6 is a flow diagram of detailed operations, in accordance with an example embodiment, for presetting a size of a grid layout based on the window size;

FIG. 7 is a flow diagram of detailed operations, in accordance with an example embodiment, for accessing the contents associated with a search of the search query;

FIG. 8 is a schematic diagram illustrating an example embodiment of the calculation of a size of a rectangular portion of a grid layout;

FIG. 9 is a diagram of a GUI, in accordance with an example embodiment, for providing information associated with contents retrieved from a search; and

FIG. 10 is a simplified block diagram of an example embodiment of a representation of a machine in the example form of a computer system.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

### Overview

In an example embodiment, a method for displaying a search result is provided. The method may comprise receiving a search query and a window size of a Web browser and accessing contents associated with a search of the search query. The contents are rendered to provide rendered images and each of the rendered images is scaled to a size of a rectangular portion of a grid layout. The size of the rectangular portion is based on the window size and a size of the grid layout. The scaled rendered images are transmitted to the Web browser, wherein the scaled rendered images are configured to be displayed in the grid layout.

### Example Embodiments

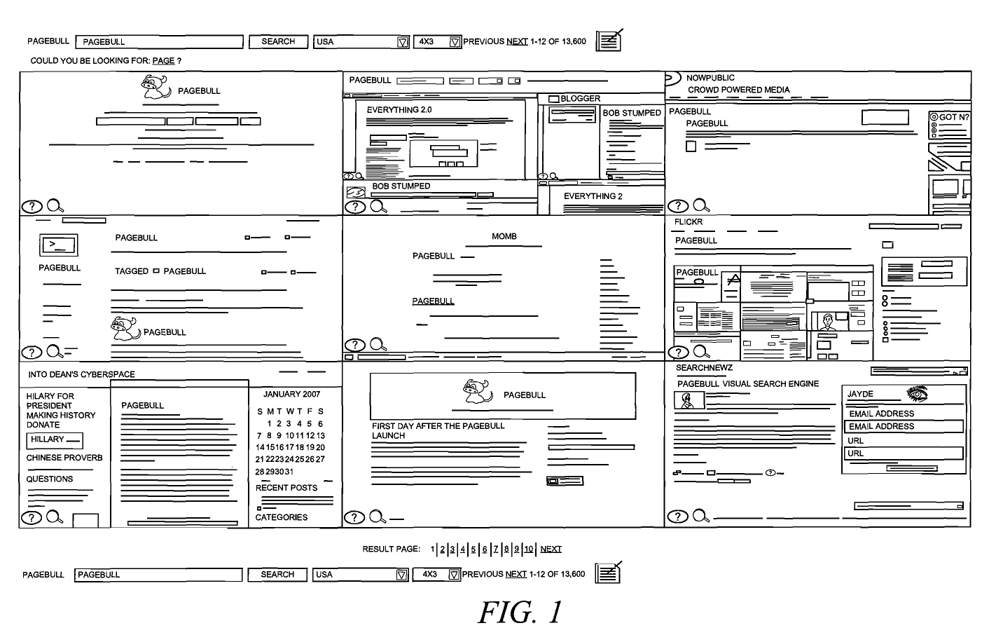

FIG. 1 is a diagram of an example embodiment of a graphical user interface (GUI) configured to display search results. The embodiments described herein provide methods, instructions, and apparatuses for displaying search results. A user may submit a search query to a search engine to locate contents on, for example, the Internet that satisfy the search query. In general, after the contents are located, screenshots of the contents are displayed or presented to the user. As shown in FIG. 1, the screenshots, which are also referred to as scaled rendered images, are displayed in a grid layout. A grid layout is a system of straight lines intersecting at right angles for use to structure and position scaled rendered images. A table is an example of a grid layout. The grid layout is divided into a number of rectangular portions and, as explained in more detail below, each of the scaled rendered images is located in each of the rectangular portions, which may be adjacent to each other.

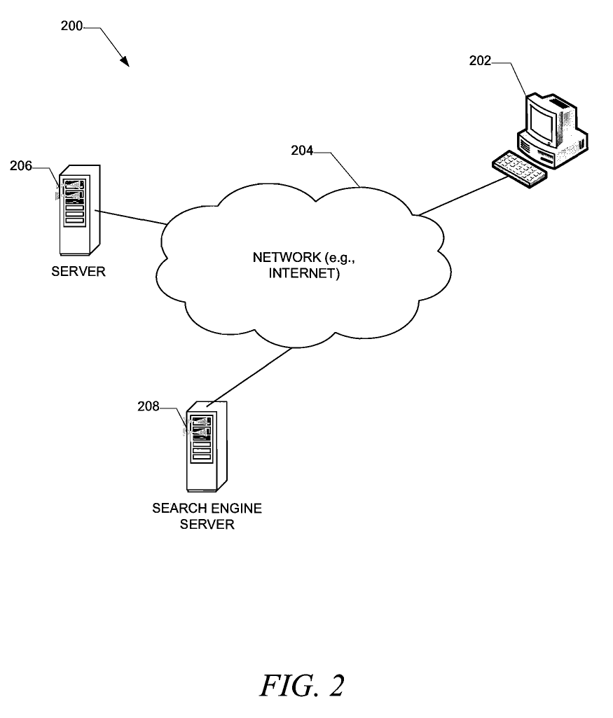

FIG. 2 is a diagram of an example embodiment of a networked system. Example system 200 includes various computing devices 206, 208, and 202 in communication by way of network 204 which may include one or more Local Area Networks (LANs) and/or Wide Area Networks (WANs), such as the Internet. As shown in FIG. 2, system 200 includes client computing device 202, server 206, and search engine server 208. Client computing device 202 is configured to host a Web browser. The Web browser is an application that enables the display of contents of a Web page. Contents may include, for example, text, images, sounds, videos, animations, and other information. The contents may be stored on server 206 or other computing devices. Server 206 and search engine server 208 may therefore provide server-side functionality, by way of network 204, to one or more clients, such as client computing device 202.

Client computing device 202 may access various services and functions supported by server 206 and search engine server 208. For example, search engine server 208 may host a search engine that is configured to search for contents stored on the World Wide Web, within a local network, or in a computing device (e.g., server 206 or client computing device 202). Examples of search engines include Web search engines, enterprise search engines, and mobile search engines. As explained in more detail below, server 206 may host a display results module that accesses the contents from a search and provides the display of contents in a grid layout to client computing device 202. It should be noted that while system 200 shown in FIG. 2 employs a client-server architecture, the present disclosure is not limited to such an architecture, and could equally well find application in a distributed, or peer-to-peer, architecture system.

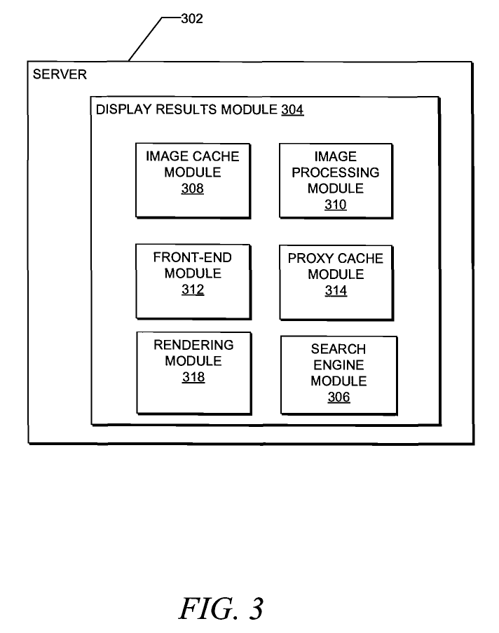

FIG. 3 is a simplified block diagram of an example embodiment of modules that may be included in an apparatus. Example of apparatus 302 may include a variety of computing devices, such as server 206 depicted in FIG. 2. In various embodiments, apparatus 302 may be used to implement computer programs, logic, applications, methods, processes, or other software to display search results. As shown in FIG. 3, apparatus 302 may host display results module 304. In an example embodiment, display results module 304 may include search engine module 306, image cache module 308, image processing module 310, rendering module 318, front-end module 312, and proxy cache module 314.

In an example embodiment, front-end module 312 may receive a search query and a window size of a Web browser. In another example embodiment, front-end module 312 may additionally receive a size of a grid layout. The search query, the window size, and the size of the grid layout may be received from a Web browser hosted at a client computing device. The search query is a query that a user enters into a search engine to satisfy his information needs. Examples of search queries include key words, strings, parameters, and other search queries. The window size of a Web browser is the size of an area inside the Web browser window that can be used to display contents. For example, the window size can be the window size of a Web browser excluding the area occupied by graphical user interface control elements such as scrollbars and buttons. An example of a window size is the width (in pixels) of the area. In another example, the window size is the width (in pixels) and the height (in pixels) of the area.

The size of the grid layout is the number of rectangular portions along a horizontal row and a vertical column. An example of a size of a grid layout is three horizontal rows of rectangular portions by four vertical columns of rectangular portions (or 3×4). Another example of a size of a grid layout is four horizontal rows of rectangular portions by three vertical columns of rectangular portions (or 4×3). In still another example, a size of a grid layout is at least two horizontal rows of rectangular portions by at least two vertical columns of rectangular portions. The size of the grid layout, in another example, can be at least two horizontal rows of rectangular portions. Alternatively, in an example, the size of the grid layout can be at least four vertical columns of rectangular portions. Other examples include 2×4, 2×6, 6×6 and other sizes. In an example embodiment, as explained in more detail below, front-end module 312 may additionally be configured to calculate a size of a rectangular portion of the grid layout and transmit scaled rendered images to a Web browser.

Still referring to FIG. 3, display results module 304 also is configured to access contents associated with a search of the search query. In an example embodiment, display results module 304 may include search engine module 306 that is configured to search for and retrieve contents associated with a search of a search query. In another example embodiment, as explained in more detail below, display results module 304 may include proxy cache module 314 that is configured access the contents with the use of another search engine not included in display results module 304. Proxy cache module 314 retrieves the contents and may temporarily store the retrieved contents in its cache system.

Before the contents are sent to rendering module 318 for processing, the contents may be parsed for occurrence of alphanumeric strings that match the search query, in accordance with an example embodiment. The alphanumeric strings are then highlighted. To highlight an alphanumeric string is to emphasize the alphanumeric string or to make the alphanumeric strings prominent. An alphanumeric string may be highlighted, for example, by assigning the alphanumeric strings a particular print style (bold, italic, underlined, and other styles), underlying the alphanumeric strings with a certain color (e.g., yellow, red, orange, and other colors), and other highlights.

Rendering module 318 then renders the contents to provide rendered images. Generally, a rendered image includes a visual representation of the contents. A screenshot is an example of a rendered image. Image processing module 310 may then store the rendered images in image cache module 308. It should be noted that subsequent requests for the same rendered images may be retrieved from image cache module 308 without repeating the retrieval and rendering process described above. Image processing module 310 thereafter scales each of the rendered images to a size of a rectangular portion of a grid layout. The scaled rendered image therefore is a rendering of contents associated with a search of the search query. As explained in more detail below, the size of the rectangular portion is based on the window size of the Web browser and a size of the grid layout.

It should be appreciated that in other embodiments, apparatus 302 may include fewer, more, or different modules apart from those shown in FIG. 3. For example, in an example embodiment, display results module 304 may not include search engine module 306 because the display results module uses an external search engine for the search.

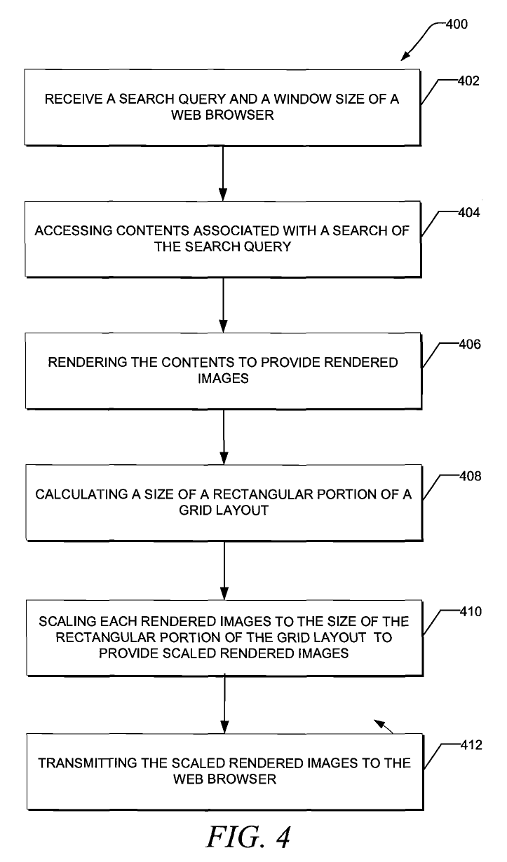

FIG. 4 is a flow diagram of a general overview of a method, in accordance with an example embodiment, for displaying a search result. In one example embodiment, method 400 may be implemented by display results module 304 of FIG. 3, employed in an apparatus, such as server 206 of FIG. 2. As shown in FIG. 4, in an example embodiment, a search query and a window size of a Web browser are received at 402. A size of a grid layout also may be received, in accordance with another example embodiment. The search query, the window size, and the size of the grid layout may be received from a Web browser hosted at a client computing device.

At 404, the contents associated with a search of the search query are accessed, which will be explained in more detail below. In an example embodiment, before the contents are rendered, alphanumeric strings within the contents that match the search query may be highlighted. In another example embodiment, the alphanumeric strings are not highlighted. At 406, the contents then are rendered to provide rendered images. Generally, rendering is the process of generating an image from the contents. The image can be the same image displayed at a Web browser. An example of a rendered image is a screenshot of a Web page. The rendered images can be in a variety of graphics formats, such as WINDOWS bitmap, Joint Photographic Experts Group (JPEG), Portable Document Format (PDF), PostScript, and other graphics formats. In an example embodiment, a size of a rectangular portion of a grid layout is calculated at 408. As explained in more detail below, the size may be calculated based on the window size and the size of the grid layout. Alternatively, in another example embodiment, the size of the rectangular portion may be preset to a particular size (e.g., 400×300 pixels, 500×375 pixels, 600×450 pixels, and other sizes).

Each of the rendered images then are scaled to the size of the rectangular portion of the grid layout at 410 to provide scaled rendered images. For example, a rendered image with a size of 1024×768 pixels can be scaled to a smaller size of 400×300 pixels that matches the size of the rectangular portion of the grid layout. It should be appreciated that bilinear resampling, for example, or other scaling algorithms may be used to scale the rendered images. After the rendered images are scaled, the scaled rendered images may be transmitted to a Web browser for display at 412. In an example, the scaled rendered images are transmitted in the form of a Hypertext Markup Language (HTML) Web page. The scaled rendered images are to be configured for display in a grid layout. Here, one scaled rendered image corresponds to one rectangular portion. For example, each of the scaled rendered images is to be located in each of the rectangular portions of the grid layout. In an example embodiment, a rectangular portion may be adjacent to other rectangular portions. A rectangular portion is adjacent to another rectangular portion when both rectangular portions are lying near or contiguous. As used herein, a rectangular portion is near another rectangular portion if the distance between borders of the two rectangular portions ranges from 0-50 pixels. Since the scaled rendered images are to be located in the rectangular portions, then each of the scaled rendered images may also be adjacent to other scaled rendered images.

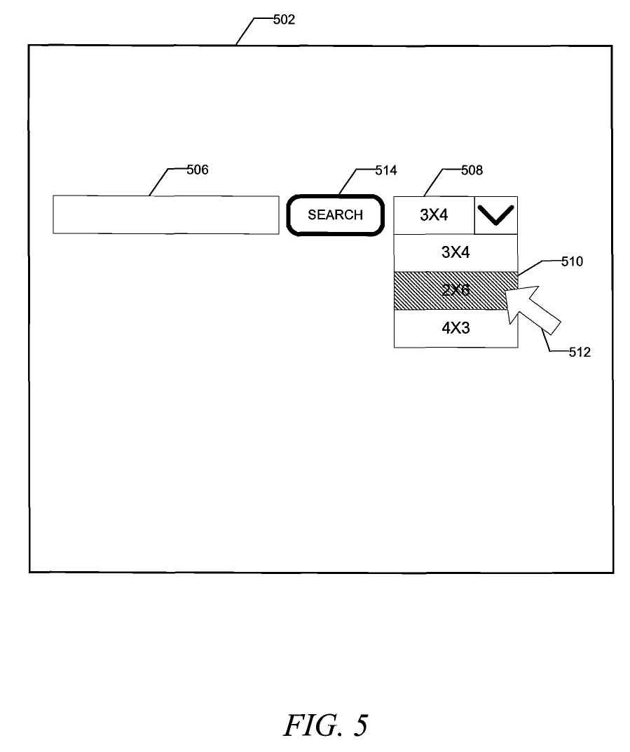

FIG. 5 is a diagram of an example embodiment of a GUI for inputting a size of a grid layout. As discussed above, a size of a grid layout may be received by a display results module. In an example embodiment, a user may use a Web browser hosted at a client computing device to input the size of the grid layout. FIG. 5 illustrates an example of GUI 502 that may be displayed in a Web browser. GUI 502, for example, may be associated with a Web page. GUI 502 may include search query input region 506, search button 514, and size input region 508. A user may input a search query within search query input region 506. In addition, the user may also input a size of the grid layout by selecting one of many sizes from size input region 508. In this example, the user may click on or select size input region 508 with the use of cursor 512. In response, a list of multiple sizes is displayed. As show in FIG. 5, the sizes available for selection are 3×4, 2×6, and 4×3. To select a size of the grid layout, the user selects a region associated with 3×4, 2×6, or 4×3. In this example, the user selects 2×6, which is highlighted with a hatched pattern. With the search query inputted in search query input region 506 and 2×6 size selected, the user may initiate transfer of the search query and the size of the grid layout to the display results module by clicking on search button 514. In another example embodiment, the size of the grid layout is preset and the user therefore does not need to input the size. As will be explained in more detail below, the size of the grid layout may be preset based on the window size.

The search query and the size of the grid layout may be transmitted in a variety of data formats. In an example embodiment, the search query and the size of the grid layout may be transmitted to the display results module by way of a link. Here, the search query and the size of the grid layout may be embedded within a link. A link is a string of alphanumeric characters that identifies content. For example, a link can include an address that identifies the location of content located on the Internet. A Uniform Resource Identifier (URI) and a Uniform Resource Locator (URL) are examples of links. An example of a URI with embedded search query and size is: http://pagebull.com/?qStart=0&VisWidth=1659&qIn=cars&qLoc=us&qPvPics=4×3. The search query “cars” and the “4×3” size of the grid layout are embedded in the query component of the example URI. It should be noted that the query component of the URI is indicated by the first question mark “?” character and terminated by a number sign (“#”) character or by the end of the URI. In addition, the window size of “1659” pixels in width is also embedded in the query component of the above-referenced URI.

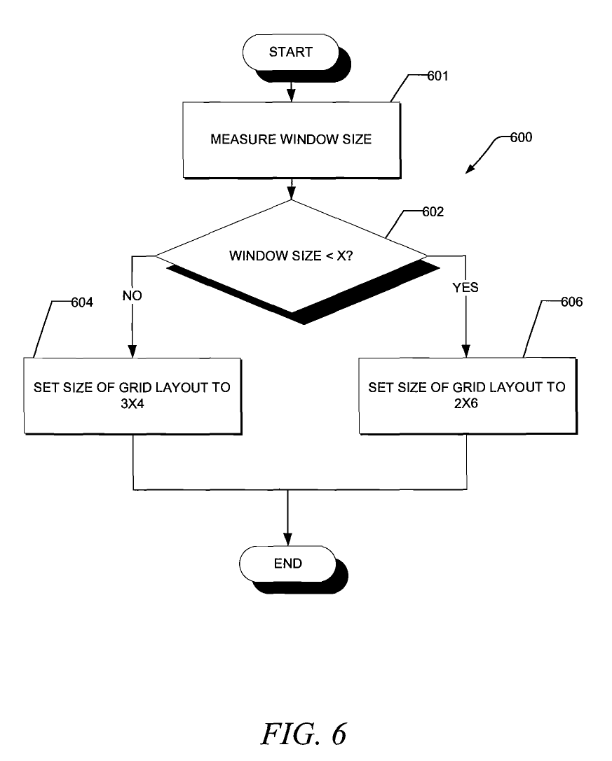

FIG. 6 is a flow diagram of detailed operations, in accordance with an example embodiment, for presetting a size of a grid layout based on the window size. It should be appreciated that a set size may not be suitable or optimized for a given widow size. For example, a set size may result in scaled rendered images displayed in a Web browser with low image quality. Accordingly, the size may be adjusted to provide scaled rendered images with high image quality. In one example embodiment, method 600 may be implemented by a module within a Web browser that is employed at a client computing device. In another example embodiment, method may be implemented by display results module 304 of FIG. 3, employed in an apparatus, such as server 206 of FIG. 2.

Starting at 601, the window size is measured. An example of a window size is the width of an area (e.g., 1612 pixels, 1416 pixels, and other widths). The window size is then compared to a threshold value X at 602. The threshold value X can include a variety of predetermined values. For example, X may be 1200 pixels, 1600 pixels, or other predetermined values. If the window size is less than the threshold value X, then the size of the grid layout is set to 3×4 at 604. On the other hand, if the window size is greater than the threshold value X, then the size of the grid layout is set to a different size of 2×6 at 606. It should be noted that in an example embodiment, the user may be given an option override the preset size of the grid layout determined by method 600 to a different size. In FIG. 6, for example, a user may override the preset size 3×4 or 2×6 with a different size, such as 4×4 or other sizes.

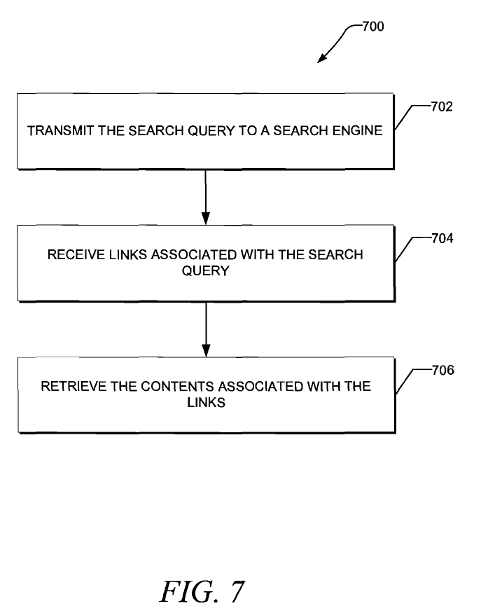

FIG. 7 is a flow diagram of detailed operations, in accordance with an example embodiment, for accessing the contents associated with a search of the search query. In one example embodiment, method 700 may be implemented by display results module 304 of FIG. 3, employed in an apparatus, such as server 206 of FIG. 2. In an example embodiment, to access contents, the display results module may search for contents that satisfy the search query. With the contents located, the contents are retrieved. In another example embodiment, as shown in FIG. 7 at 702, the display results module may transmit the search query to a search engine. In an example, the search engine may be a Web search engine and is hosted on search engine server 208 depicted in FIG. 2. The search engine may be configured to search for contents that satisfy the search query and to provide links to the contents.

In response, the links associated with the search query are received at 704. As discussed above, a link can include an address that identifies the location of content located on the Internet. With the location of the content identified, the contents associated with the links can be retrieved at 706. For example, contents may be retrieved by way of Hypertext Transfer Protocol (HTTP) for a given URL.

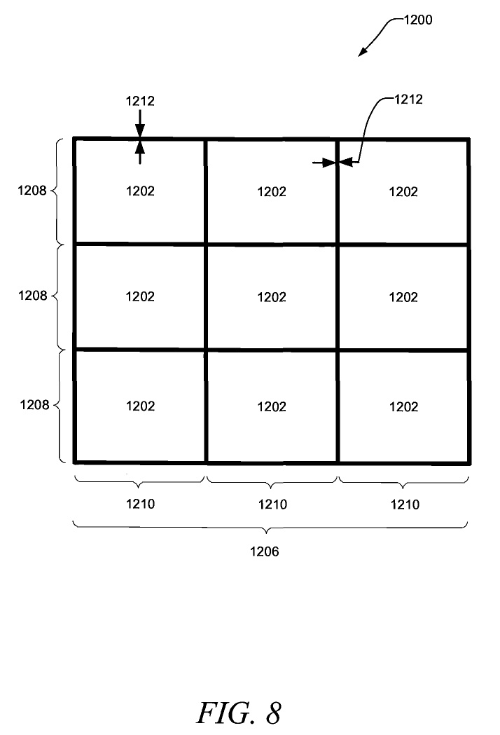

FIG. 8 is a schematic diagram illustrating an example embodiment of the calculation of a size of a rectangular portion of a grid layout. As shown in FIG. 8, example grid layout 1200 is comprised of nine rectangular portions 1202. The size of grid layout 1200 is three horizontal rows of rectangular portions 1202 by three vertical columns of the rectangular portions (or 3×3). The size of each rectangular portion 1202 is defined by height 1208 and width 1210. Height 1208 and width 1210 can be calculated based on the window size and the size of grid layout 1200. In an example, width (W) 1210 of rectangular portion 1202 can be expressed as:

W=Window Size/HR (1.0)

where Window Size is the width of the window size and HR is the horizontal rows of rectangular portions associated with the size of grid layout 1200. Width 1210 can include a variety of lengths. In an example embodiment, width 1210 can be equal to or greater than 400 pixels. Height 1208 of rectangular portion 1202 can be based on width 1210. In an example embodiment, height (H) 1208 of rectangular portion 1202 can be expressed as:

H=(W/4)*3 (1.1)

where W is the width calculated in Equation 1.0. If width 1210 and/or height 1208 result in a decimal value, the decimal value may be rounded up or down to the next integer value. In the example shown in FIG. 8, a window size of 1500 pixels in width and a 3×3 size of grid layout 1200 are provided. As expressed in Equation 1.0, width 1210 is 1500/3, which defines the width as 500 pixels. Height 1208, as expressed in Equation 1.1, is (500/4)*3, which defines the height as 375 pixels.

When displayed, each rectangular portion 1202 may be surrounded or defined by a border. A frame is an example of a border. The border defines the boundaries of each rectangular portion 1202 and separates one rectangular portion from another rectangular portion. In an example, a border may be lines around the edges of each rectangular portion 1202. The lines may have thickness 1212. In an example embodiment, thickness 1212 of border can range from 1 to 4 pixels. Alternatively, in another example embodiment, thickness 1212 of border can range from 5-20 pixels. FIG. 8 shows border with rectangular shapes, but it should be noted that the border may include a variety of different shapes. For example, border may have rectangular shapes with rounded corners.

Height 1208 and width 1210 may be calculated differently if rectangular portions 1202 are surrounded by a border. In an example embodiment, height 1208 and width 1210 may be based, in part, on thickness 1212 of border. With a 2×2 size of grid layout, for example, thickness 1212 may be multiplied by four and then deducted from width 1206 of window size. Width 1210 can be calculated by dividing the resulting value by two and rounding down to the next integer value. With a 3×3 size of grid layout, for example, thickness 1212 may be multiplied by six and then deducted from width 1206 of window size. Width 1210 can be calculated by dividing the resulting value by three and rounding down to the next integer value.

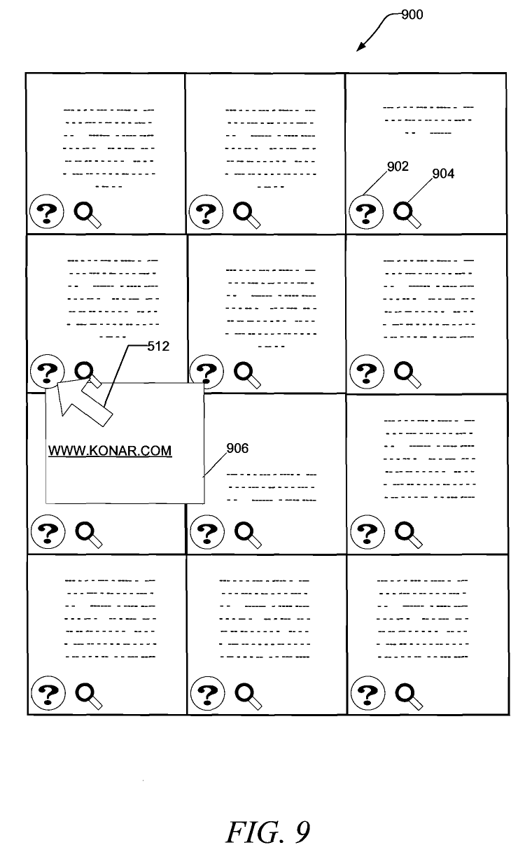

FIG. 9 is a diagram of a GUI, in accordance with an example embodiment, for providing information associated with contents retrieved from a search. FIG. 9 illustrates an example of GUI 900 that may be displayed in a Web browser. GUI 900, for example, may be associated with a Web page. GUI 900 is comprised of scaled rendered images displayed in a grid layout. Each rectangular portion of the grid layout may include information button 902 and/or magnify button 904. A user may click on or select magnify button 904 with the use of cursor 512. In response, a larger view of the scaled rendered image is displayed. The user may additionally click on or select information button 902. In response, a list of information is displayed. The list may include a variety of information associated with the content. For example, the information may include a link to the content. In another example, the information may include text retrieved from a search.

It should be appreciated that any number of suitable layouts can be designated for region and button layouts illustrated above as FIGS. 1, 5, 8, and 9 do not represent all possible layout options available. The displayable appearance of the regions and buttons can be defined by a variety of geometric shapes (e.g., rectangle, square, circle, triangle, etc.), alphanumeric characters (e.g., A, V, t, Q, 1, 9, 10, etc.), symbols (e.g., $, *, @, Ω, ∞, etc.), shading, pattern (e.g. solid, hatch, stripes, dots, etc.), and color. Furthermore, for example, search query input region 506 of FIG. 5, or other regions, may be omitted or dynamically assigned. It should also be appreciated that the regions can be fixed or customizable. In addition, the computing devices may have a fixed set of layouts, utilize a defined protocol or language to define a layout, or an external structure can be reported to the computing device that defines the layout. Finally, clicking or selecting on a region or button of GUI as discussed above may trigger code to cause the functionality described herein.

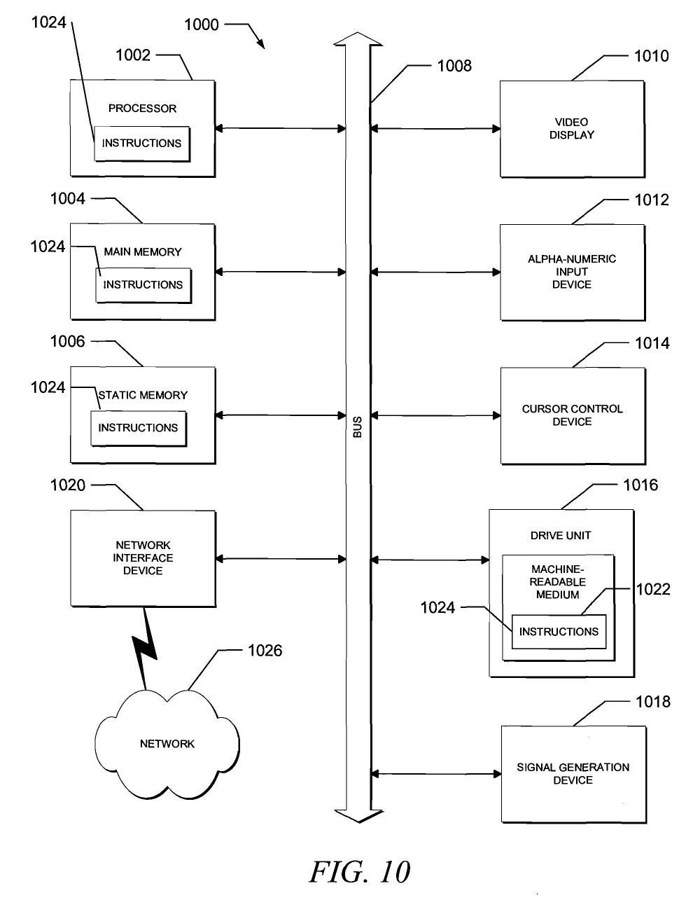

FIG. 10 shows a diagrammatic representation of an example embodiment of a machine in the example form of computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1000 includes processor 1002 (e.g., a central processing unit (CPU), a graphics processing unit (GPU) or both), main memory 1004 and static memory 1006, which communicate with each other via bus 1008. Computer system 1000 may further include video display unit 1010 (e.g., a plasma display, a liquid crystal display (LCD) or a cathode ray tube (CRT)). Computer system 1000 also includes alphanumeric input device 1012 (e.g., a keyboard), user interface (UI) navigation device 1014 (e.g., a mouse), disk drive unit 1016, signal generation device 1018 (e.g., a speaker) and network interface device 1020.

Disk drive unit 1016 includes machine-readable medium 1022 on which is stored one or more sets of instructions and data structures (e.g., software 1024) embodying or utilized by any one or more of the methodologies or functions described herein. Software 1024 may also reside, completely or at least partially, within main memory 1004 and/or within processor 1002 during execution thereof by computer system 1000, main memory 1004 and processor 1002 also constituting machine-readable media.

Software 1024 may further be transmitted or received over network 1026 via network interface device 1020 utilizing any one of a number of well-known transfer protocols (e.g., HTTP).

While machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an example embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for displaying a search result, comprising:
receiving a search query and a window size of a Web browser;
accessing a plurality of contents associated with a search of the search query;
rendering the plurality of contents to provide a plurality of rendered images;
scaling each of the plurality of rendered images to a size of a rectangular portion of a grid layout to provide a plurality of scaled rendered images, the size of the rectangular portion being based on the window size and a size of the grid layout; and
transmitting the plurality of scaled rendered images to the Web browser, the plurality of scaled rendered images being configured to be displayed in the grid layout.

2. The method of claim 1, wherein the accessing the plurality of contents comprises:
transmitting the search query to a search engine;
receiving a plurality of links associated with the search of the search query; and
retrieving the plurality of contents associated with the plurality of links.

3. The method of claim 1, further comprising receiving the size of the grid layout.

4. The method of claim 1, further comprising highlighting an alphanumeric string within the plurality of contents that matches the search query.

5. The method of claim 1, wherein the grid layout is divided into a plurality of rectangular portions, each of the plurality of scaled rendered images being configured to be located in each of the plurality of rectangular portions.

6. The method of claim 1, wherein the grid layout comprises a horizontal row of two rectangular portions and a vertical column of two rectangular portions.

7. A machine-readable medium comprising instructions, which when implemented by one or more processors perform the following operations:
receiving a search query, a window size of a Web browser, and a size of a grid layout;
accessing a plurality of contents associated with a search of the search query;
rendering the plurality of contents to provide a plurality of rendered images;
calculating a size of a rectangular portion of the grid layout based on the window size and the size of the grid layout;
scaling each of the plurality of rendered images to the size to provide a plurality of scaled rendered images; and
transmitting the plurality of scaled rendered images to the Web browser, the plurality of scaled rendered images being configured to be displayed in the grid layout.

8. The machine-readable medium of claim 7, wherein the operation for accessing the plurality of contents comprises:
transmitting the search query to a search engine;
receiving a plurality of links associated with the search of the search query; and
retrieving the plurality of contents associated with the plurality of links.

9. The machine-readable medium of claim 7, further comprising highlighting an alphanumeric string within the plurality of contents that matches the search query.

10. The machine-readable medium of claim 7, wherein the grid layout is divided into a plurality of adjacent rectangular portions, each of the plurality of scaled rendered images being configured to be located in each of the plurality of adjacent rectangular portions.

11. The machine-readable medium of claim 7, wherein the grid layout comprises a horizontal row of two rectangular portions and a vertical column of three rectangular portions.

12. The machine-readable medium of claim 7, wherein the size of the rectangular portion is greater than 400 pixels in width.

13. An apparatus comprising:
a memory configured to store a search display results module; and
a processor in communication with the memory, the processor being configured to execute the search display results module, the search display results module comprising:
a front-end module configured to:
receive a search query, a window size of a Web browser, and a size of a grid layout;
calculate a size of a rectangular portion of a grid layout based on the window size and the size of the grid layout; and
transmit a plurality of scaled rendered images to the Web browser, the plurality of scaled rendered images being configured to be displayed in the grid layout;
a proxy cache module configured to:
transmit the search query to a search engine;
receive a plurality of links associated with the search query; and
retrieve a plurality of contents associated with the plurality of links;
a rendering module configured to render the plurality of contents to provide a plurality of rendered images; and
an image processing module configured to scale each of the plurality of rendered images to the size of the rectangular portion to provide the plurality of scaled rendered images.

14. The apparatus of claim 13, wherein the front-end module is further configured to highlight an alphanumeric string within the plurality of contents that matches the search query.

15. The apparatus of claim 13, wherein the grid layout is divided into a plurality of adjacent rectangular portions, each of the plurality of scaled rendered images being configured to be located in each of the plurality of adjacent rectangular portions.

16. The apparatus of claim 13, wherein the grid layout comprises a horizontal row of two rectangular portions and a vertical column of two rectangular portions.

17. The apparatus of claim 13, wherein the apparatus is a server.

18. A method for displaying a search result, comprising providing a plurality of scaled rendered images, the scaled rendered images being configured to be a rendering of contents associated with a search of a search query, the plurality of scaled rendered images being configured to be displayed in a grid layout.
